(19) United States
(12) Patent Application Publication
(10) Pub. No.: US 2020/0195794 A1
(43) Pub. Date: Jun. 18, 2020

(54) METHOD AND DEVICE TO MANAGE DIFFERENT SCREENS WITH DIFFERENT SIZES ON A PRINTER

(71) Applicant: DOVER EUROPE SÀRL, Vernier (CH)

(72) Inventor: Elisabeth Martin, Chatuzange Le Goubet (FR)

(21) Appl. No.: 16/603,041

(22) PCT Filed: Apr. 7, 2017
(86) PCT No.: PCT/IB2017/000601

§ 371 Date: Oct. 4, 2019

(51) Int. Cl. H04N 1/00

(52) U.S. Cl. CPC H04N 1/00411

(57) ABSTRACT

A printing system comprising several industrial printers, each printer comprising a controller to control printing operations, the system further comprising a common user interface, one of the controllers being programmed to simultaneously display on the common user interface and information relating to at least two of the printers and/or of printing operations performed by the printers.

### TECHNICAL FIELD AND PRIOR ART

The invention relates to the field of industrial printers, and in particular for coding and/or marking. Different kinds of printer can be concerned, for example continuous ink jet (CU) printers. Other kinds of printers are also concerned, for example industrial laser printers or printers based on an industrial thermal transfer technology.

In an industrial printing system, an industrial printer is typically configured to print different types of information on various types of information carriers, such as the products themselves or their packaging. One example of an operation of such an industrial printer is the printing of print information data on various types of packages or goods. Commonly, such packages or goods require a great deal of product identifications and content specifications, for example, traceability data, serial numbers, time and dates of packaging, expiry dates, etc. Therefore, the print information data to be printed on the goods or on their packaging may vary from one item to the next in a batch of items, from one batch of items to another, from one site of manufacture to another, from one time of manufacture to another, from one type of print technology to another, etc.

The print information may comprise both print information data and print information instructions. The print information data may comprise, for example, references to printer ready bitmap images, such as, e.g. barcodes, or the print ready information to be printed as it is; the print information instructions on the other hand may comprise, for example, code algorithms for the printer to determine print information data on-the-fly, i.e. as it is being printed, such as, e.g. incremental enumerations, or coded instructions indicating how the print information data is to be printed on the information carrier. This print information data and instructions also conforms into a specific print information format.

Such printers are for coding and/or marking, or, more generally, for adding information, on a surface of an object or of its packaging.

In such industrial printers, the surfaces to be printed on are sometimes not flat, for example when printing must be performed directly on the surface of an object like bottles or cans or containers or cables.

Continuous ink jet (CU) printers are well known in the field of industrial coding and labelling for various products, for example to label barcodes, expiration date on food products, or to print references or distance marks on cables or pipes directly on the production line and at a high rate. This kind of printer is also found in some fields of decoration where the graphic printing possibilities of the technology are exploited.

CIJ printers have several standard sub-assemblies as shown in FIG. 1A.

First, a printing head 1, generally offset from the body of the printer 3, is connected thereto by a flexible umbilical 19 joining the hydraulic and electrical connections required for operating the head by imparting it flexibility which facilitates integration on the production line.

The body of the printer 3 usually contains three sub-assemblies:
an ink circuit at the lower portion of said body (zone 4′), which enables, on the one hand, ink to be provided to the head at a stable pressure and with a suitable quality, and, on the other hand, the jet ink not used for printing to be accommodated;
a controller located at the upper portion of said body (zone 5′), capable of managing the action sequencing and performing processes enabling different functions of the ink circuit and of the head to be activated. The controller can include for example a micro-computer or a micro-processor and/or one (or more) electronic board and/or at least one embedded software, the programming of which ensures driving the ink circuit and the printing head 1. This controller allows the printing instructions to be transmitted to the head but also the system engines and valves to be driven in order to manage supplying ink and/or solvent to the circuit with as well as recovering the ink and air mixture from the head; it is thus programmed to that end.
an interface which gives the operator means for implementing the printer and to be informed about its operation.

In other words, the body includes 2 sub-assemblies: at the upper portion, the electronics, the electric supply, and the operator interface, and at the lower portion, an ink circuit providing pressurised ink, with a rated quality, to the head and the trough for recovering the ink not used by the head.

FIG. 1B schematically represents a printing head 1 of a CIJ printer. It includes a drop generator 116 fed with electrically conducting ink, pressurised by the ink circuit.

This generator is capable of emitting at least one continuous jet through a small dimension port called a nozzle. The jet is transformed into a regular succession of drops having an identical size under the action of a periodical stimulation system (not represented) located upstream of the nozzle outlet. When the drops 7 are not for printing, they are directed to a gutter 119 which recovers them in order to recycle unused ink to bring them back into the ink circuit. Devices 117, 118, 118′ (charging and deflection electrodes) placed along the jet enable, by a command, the drops to be electrically charged and deflected in an electric field Ed.

Consequently, they are deviated from their natural trajectory of ejection from the drop generator. The drops 9 for printing avoid the gutter and will be deposited on the medium to be printed 8.

This description can be applied to so-called binary or multi-deflected continuous jet versions of continuous ink jet (CU) printers. The binary CIJ printers are equipped with a head the drop generator of which has a multitude of jets, each drop of a jet can only be oriented to 2 trajectories: printing or recovery. In multi-deflected continuous jet printers, each drop of a single jet (or of some spaced jets) can be deflected to various trajectories corresponding to charging commands being different from one drop to the other, thus making a sweeping of the zone to be printed along a direction which is the deflection direction, the other sweeping direction of the zone to be printed is covered by relatively displacing the printing head and the medium to be printed 8. Generally, the elements are arranged such that these 2 directions are substantially perpendicular.

An ink circuit of a continuous ink jet printer enables, on the one hand, ink under a controlled pressure, and possibly solvent, to be provided to the drop generator of the head 1 and, on the other hand, a trough to be created to recover unused fluids for printing and which then come back from the head.

It also enables consumables (ink and solvent delivery from a reservoir) to be managed and ink quality (viscosity/concentration) to be controlled and maintained. Ink is also a consumable in the case of printers of the “valvejet” type, or of a printer of the piezo-liquid ink type or of a printer of the thermal ink jet type. ‘Hotmelt”, which is ink which can be made liquid upon heating, is also a consumable product, but has to be heated by the ink management system to be liquid for printing.

Finally, other functions are related to the user comfort and the automatic takeover of some maintenance operations in order to ensure a constant operation regardless of the conditions of use. Among these functions, there are the solvent rinsing of the head (drop generator, nozzle, gutter), preventive maintenance head, for example replacing components having a limited lifetime, in particular filters, and/or pumps.

These different functions have very different purposes and technical requirements. They are activated and sequenced by the printer controller which will be all the more complex as the number and sophistication of the functions are great.

The above example concerns a CIJ printer, but other printer technologies are also concerned by the invention, for example industrial laser printers. An industrial laser printer has a laser source and mirrors but does not have any ink or solvent management system nor any hydraulic connection. In other technologies, use is made of a thermal ribbon, which is then the consumable material.

Different functions are also fulfilled by other kinds of printers where consumables can be different from ink. A ribbon is the consumable material in the case of a “print and apply” printer or of a “TTO” printer. A laser source of an industrial laser printer directly engraves a mark in a material or burns the material to mark it. The laser tube has a limited life time, which can be compared to a print head which wears out, but, as such, is not a consumable. The laser burns the first overlay to let discover the second layer or engraves the material. The particle burns/engraves create fumes. A fume extractor usually has a filter which needs to be replaced and which is a consumable material.

Furthermore, an industrial printer can be integrated in a single cabinet or be split up between several boxes or cabinets where for example the print head, controller, consumables supply are in separate boxes or cabinets. This is in particular the case when a printer is used with a packaging machine.

In a known approach, a printer, for example of one of the types discussed above, has a user interface which is fixed with respect to the printer body or controller, and which is the same from one printer to another same printer.

There is therefore no flexibility in the size of the interface, preventing two same printers to have different user interfaces, for example one of the user interfaces having a size different than the other the user interface.

In particular, a printer being equipped with a user interface of a particular type or size, the use of a different user interface, being of another type or another size, is not possible.

It is also impossible, with a same user interface, to manage different printers, the information displayed on a user interface being adapted to one and only one printer. In a printer system comprising several printers, which can operate at the same time, the operator needs to move from one printer to another printer to have the relevant information for each of them. This kind of situation can be encountered when several printers are implemented or integrated in a same packaging unit or production unit. In such a situation, the operator cannot, at the same time, move away from the controller of a particular printer and still be aware of the information being displayed on the user interface of said particular printer, in particular of the technical information relating to said printer.

Going away from the controller of one particular 1^{st} printer can sometimes be necessary to check another printer, for example its printing head or a conveyor transporting objects to be printed by said other printer. In such case the operator can miss important information concerning said printer, for example a failure or a warning information.

For example, several printers or print heads are managed in some systems of the TTO type (“Thermal Transfer on line”), or of the LCIJ type (“Large Character Ink Jet”).

There is also a need, in such case, for displaying information relating to one or the other of the printers depending, for example, on the position of an operator with respect to the different printers.

Furthermore, in a same system comprising several printers, the different printers can be of different types, for example one CIJ printer and one laser printer. There is a need, in such case, for displaying an information adapted to the printer concerned, for example the printer which is the closest to the operator or the printer selected by the operator.

### SUMMARY OF THE INVENTION

A first aspect of this invention concerns at least a printer comprising a controller to control printing operations of said printer, a user interface, said controller being programmed to:
detect a parameter representing or indicating a size of said user interface;
adapt the technical information to be displayed on said user interface in particular information relating to said printer, based on said detected parameter.

The invention also concerns a method to work a printer comprising a controller to control printing operations and a user interface, said method comprising:
detecting a parameter representing or indicating a size of said user interface;
adapting or selecting the technical information to be displayed on said user interface, in particular information relating to said printer, based on said detected parameter.

The information, or the technical information, to be displayed relating to a printer is or comprises information relating to technical features of said printer and/or its status and/or a printing being (or to be) performed by said printer.

The invention also concerns a method to control printing operations, implementing a printer or a printer system according to the invention.

In a device or a method according to said first aspect of this invention, the technical information displayed or to be displayed on a 1^{st} user interface is therefore adapted to its size (or 1^{st} size).

A 2^{nd} user interface, different from the 1^{st} one, having a 2^{nd} size different from the 1^{st} size, can be used with the same printer, in place of the 1^{st} user interface or simultaneously with it; the technical information, in particular information relating to said printer, to be displayed on said 2nd user interface will be adapted by the controller, based on said 2^{nd} size: there will be more information or less information and/or said information will be displayed differently than on the 1^{st} user interface.

A different information can thus be displayed, for example simultaneously, on both user interfaces based on their size.

In a device or a method according to said first aspect of the invention, the 2^{nd} user interface can display a modified content or information, different from the content or information displayed by the 1^{st} user interface when said 1^{st} user interface is replaced by the 2^{nd} user interface or when said 1^{st} user interface and said 2^{nd} user interface are used simultaneously. When both said 1^{st} and said 2^{nd} user interfaces are used together with the same printer, the information displayed on each of said user interfaces is based on the size of the corresponding user interface.

If, for example, the 2^{nd} user interface is smaller than the 1^{st} user interface, less information can be displayed on the 2^{nd} user interface but at a same or comparable size than on the 1^{st} user interface. In such case, a 1^{st} part of the information which is presented on the 1^{st} user interface can be simultaneously displayed on the 2nd user interface; a 2^{nd} part of the same information can be presented on the 2^{nd} user interface, but not at the same time and/or not on the same page as said 1^{st} part of the information.

In one embodiment, the controller memorizes data relating to the information to be displayed at least on a 1^{st} user interface having a 1^{st} size and on a 2nd user interface having a 2^{nd} size different from the 1^{st} one. The controller detects which of the 1^{st} user interface and 2^{nd} user interface, or which of 1^{st} size and the 2^{nd} size is implemented, and adapts the information displayed accordingly, based on the memorized data.

For example, the controller is programmed to compare said detected parameter representing or indicating a size of said user interface, or said size of said user interface, with the sizes memorized and adapts the information displayed on said user interface based on the result of said comparison.

In a further embodiment, the controller memorizes data relating to the information to be displayed at least on a 1^{st} user interface having a 1^{st} size, on a 2nd user interface having a 2^{nd} size different from the 1^{st} one and on a 3rd user interface having a 3^{rd} size different from the 1^{st} one and from the 2^{nd} one. The controller detects which of at least the 1^{st} user interface, the 2^{nd} user interface, and the 3^{rd} user interface, or which of at least 1^{st} size, the 2^{nd} size, and the 3^{rd} size is implemented, and adapts the information displayed accordingly, based on the memorized data.

A printer according to the invention, or a method according to the invention, may comprise, or implement, two or more user interfaces, a 1^{st} user interface being for example embedded in, or fixed with respect to, the printer, and having a first size, which is different, for example larger, than a second size of a 2^{nd} user interface. Said 2^{nd} user interface can be mobile, for example being connected to the controller of the printer only by wireless communication means; it thus allows a user to move from the controller, for example to check a production line or a print head. Although the 2^{nd} user interface has a different size than the 1^{st} user interface, the operator can still see at least part of the information displayed on the 1^{st} user interface while being away from said 1^{st} user interface.

For example, said 1st user interface can display, in addition to other information, a message being printed, a printer status beacon or information and/or an information relating to the state of the printer and/or a local start and/or stop button and/or an information relating to a consumable and/or an information relating to maintenance intervals. The 2^{nd} user interface will just display, for example in case it is smaller than said 1st user interface, information which an operator should see at any time, such as a printer status beacon or information and/or an information relating to the state of the printer and/or a local start and/or stop button.

In an embodiment, a printer according to the invention comprises, or a method according to the invention implements or makes use of, at least one 1^{st} user interface having a 1^{st} size and at least one 2nd user interface having a 2^{nd} size different from the 1^{st} one, said controller of said printer being programmed to display on said at least one 1st user interface at least part, or only part, of the information simultaneously displayed on said at least one 2^{nd} user interface.

In a particular embodiment, a printer according to the invention comprises, or a method according to the invention implements or makes use of, a 1^{st} user interface having a 1^{st} size and a 2nd user interface having a 2^{nd} size different from the 1^{st} one, said controller being programmed to simultaneously display information on the 1st user interface and on said 2^{nd} user interface, but at least one information on the 1st user interface being different than the information displayed on said 2^{nd} user interface.

The controller can be for example programmed to display on the 2^{nd} user interface an information relating to at least one consumable material, the 1st user interface (but, in a further embodiment, not the 2^{nd} user interface), displaying how to replace said consumable material or at least one part of the printer containing said consumable material.

Said consumable material is for example ink or solvent or a part of the printer, for example a valve or a pump of a hydraulic circuit of the printer.

Said controller can be programmed to display on the 2^{nd} user interface an information relating to at least one machine vision device, to image a printing made or being made, and to display on the 1st user interface (but, in a further embodiment, not the 2^{nd} user interface), images of a printing made or being made.

In a further embodiment, said at least one 1st user interface can display at least one button or icon to provide at least one adjustment of an image displayed. Said controller can be programmed to display on one of said user interfaces an information relating to a failure or a defect or a fault of the printer, and to display (preferably only) on the other user interface information as to how to eliminate or repair said failure or defect or fault.

The invention solves in particular the problem of printer operation, and/or maintenance and/or service when a printer is integrated in a line, for example a packaging line; the control of the printer or of the line can be performed by an operator who is away from the 1^{st} user interface but who has the 2^{nd} user interface, which for example has a different size than the 1^{st} user interface, in his/her hands or on a support in front of him/her.

In a second aspect, the invention also concerns a printers system comprising at least a 1^{st} printer and at least a 2^{nd} printer, at least one of them being for example a printer according to the invention as disclosed above, a same (main), or a single, user interface being common to said both printers and displaying at least one 1^{st} information relating to the 1^{st} printer and/or to at least one printing operation(s) performed by said 1^{st} printer, and simultaneously to said at least one 1^{st} information, at least one second information relating to the 2^{nd} printer and/or to at least one printing operation(s) performed by said 2^{nd} printer. Different parts of the same user interface can thus be used as individual user interfaces smaller than the main user interface itself. A controller of one of said individual printers can be programmed to control said common user interface and to simultaneously display on said common user interface an information relating to at least two of said printers and/or of printing operations performed by said printers.

In such a printer system, said 1^{st} printer can be of a different kind than said 2^{nd} printer.

A user interface can therefore be connected to different printers and can be used to operate and/or control different printers from a same location.

In such a printers system, each one of said printers may further comprise an individual user interface, a controller of each one of said industrial printers being programmed to display on said individual user interface information relating to said one of said industrial printers only. In another embodiment, none, or at least part, of said printers has an individual user interface: information relating to all, or at least part, of said printers, can be displayed only on said common user interface.

Said controller programmed to control said common user interface may be programmed to shift from a display, on said common user interface, of simultaneous information relating to at least two said printers to a display of information relating to only one of said printers and vice-versa.

Said controller may be programmed to detect a surface or an area indicating a size available on said common user interface for each of said printers and to adapt the technical information to be displayed on said user interface based on said detected surface or area. In other words, a printer of the invention as presented first above can be one of a printers system disclosed according to the second aspect of the invention.

The invention also concerns a method to control printing operations, implementing a printers system as disclosed above according to the second aspect of the invention.

This second aspect of the invention also concerns a method to work a printing system comprising several industrial printers, each printer comprising a controller to control printing operations, said system further comprising a common user interface, one of said controllers controlling said common user interface so that it simultaneously displays an information relating to at least two of said printers and/or an information of printing operations performed by said printers.

Such a method may further comprise shifting said display on said common user interface from a display of information simultaneously for several printers to a display of information for only one printer and back to a display of information simultaneously for several printers.

The invention thus solves in particular the problem of printer operation in a printers system, and/or maintenance and/or service when several printers are integrated in a unit, for example a packaging unit; the control of each printer or of the unit can be performed by an operator who is away from each printer but who has the common user interface in hands or on a support in front of him/her.

In a printer or a printing system according to any aspect of the invention, a controller can further be programmed to display on a 1st user interface, when a 2^{nd} user interface is used at the same time as said 1^{st} user interface, only part of the information displayed on said 2^{nd} user interface, said part of the information being displayed with a different size on said 1st user interface and on said 2^{nd} user interface. Numerous examples of such an information displayed on the 1st user interface have been given above.

In another embodiment of a printer or a printing system according to any aspect of the invention, the controller is programmed to display on a 1st user interface, when a 2^{nd} user interface is used at the same time as said 1^{st} user interface, at least one different information than the information displayed on said 2^{nd} user interface. Again numerous examples of such an information displayed on said 1st user interface have been given above.

The information on said 1^{st} user interface can be therefore adapted when said 2^{nd} user interface is used at the same time as said 1^{st} user interface, so that information or data available on said 2^{nd} user interface is not displayed at the same time on said 1^{st} user interface, providing more display area and clearer information and data.

In an example, the controller is programmed so that, in case of fault or failure of the printer or of any of its component, one of the user interfaces, for example the smallest one, displays at least a warning signal or information or a fault signal or information, whereas another larger screen, for example a larger one or the largest one, can be used simultaneously or not with the same printer and displays a warning signal or information or a fault signal or information and, in addition at least a short message, not displayed on the other screen, describing the failure of the fault or indicating the nature of said failure or said fault.

In a further example, the controller is programmed so that one of said screens, but not another one, displays control means or zones to adjust print parameters and/or print quality, for example to adjust location of a drop, and/or drop size, and/or any other parameter in relation to the drop path from a nozzle to a substrate to be printed.

In further examples, the controller is programmed so that a screen, for example a larger one or the largest one, displays production information such as production rate, and/or remaining prints, and/or total prints and/or predicts when it is time to refill consumables or do maintenance, but another screen, for example a smaller one or the smallest one, does not display said information.

A printer or a printer of a system according to any aspect of the invention can be a continuous inkjet printer or a laser printer, or a thermal inkjet printer or a “print and apply” printer or a drop on demand printer or a valvejet printer.

The present invention improves the efficiency of operating a printer or a printing or packaging line comprising a printer by providing a faster and easier access to operate the printer, which reduces the down time. It also improves the efficiency by supporting an efficient location of the remote user interface to operate the printer(s).

### BRIEF DESCRIPTION OF THE DRAWINGS

FIGS. 1A and 1B show a known CIJ printer and print head structure.

FIG. 2 shows a CIJ printer with a 1^{st} user interface and then with a 2^{nd} user interface.

FIG. 3 shows a CIJ printer with both a 1^{st} user interface and a 2^{nd} user interface having different sizes.

FIGS. 4A and 4B respectively 5A1, 5A2 and 5B, respectively 6A and 6B, are examples of a display of information on a 1^{st} user interface, a 2^{nd} user interface and a 3^{rd} user interface.

FIG. 7 is an example of a display of information on a user interface to manage different printers at the same time.

FIG. 8A shows 3 conveyors, each with a printer controller and a user interface, and a mobile user interface.

FIG. 8B shows 3 conveyors, each with a printer controller, and a mobile user interface;

FIGS. 9A and 9B show a conveyor, with its printer controller and a further mobile 2^{nd} user interface;

FIGS. 10A-10C are examples of different kinds of printers which can be implemented according to the invention.

### DETAILED DESCRIPTION OF SPECIFIC EMBODIMENTS

In this specification, most of the examples are given with a CIJ printing machine. However, as already explained and as explained with more details below, other type of printing (or marking and/or coding) machines can be implemented in the frame of the invention, for example a laser printer, in order to print or mark a message or a code or, more generally, a piece of information.

A printer has a print head and a controller to control printing operations; it can also have a user interface which enables an operator to monitor the different operations being performed and sometimes to start or stop the printing operations or the printer and/or to change settings of the printer or of the printing process being performed.

The printer can be integrated into a packaging machine.

The printers concerned by the invention are industrial printers, for example which have the ability to print on a surface which is not flat, for example on a cable or a bottle or a can. Another aspect of such printers is that the distance between the printing head and the substrate which must be printed is higher than in conventional desk printers. For example that distance is at least between 4 mm and 5 mm for a CIJ printer. It is of course much longer for a laser printer.

Another aspect of such printers is that they can print on very different surfaces, for example on glass, or on metal or on blisters or on packaging materials.

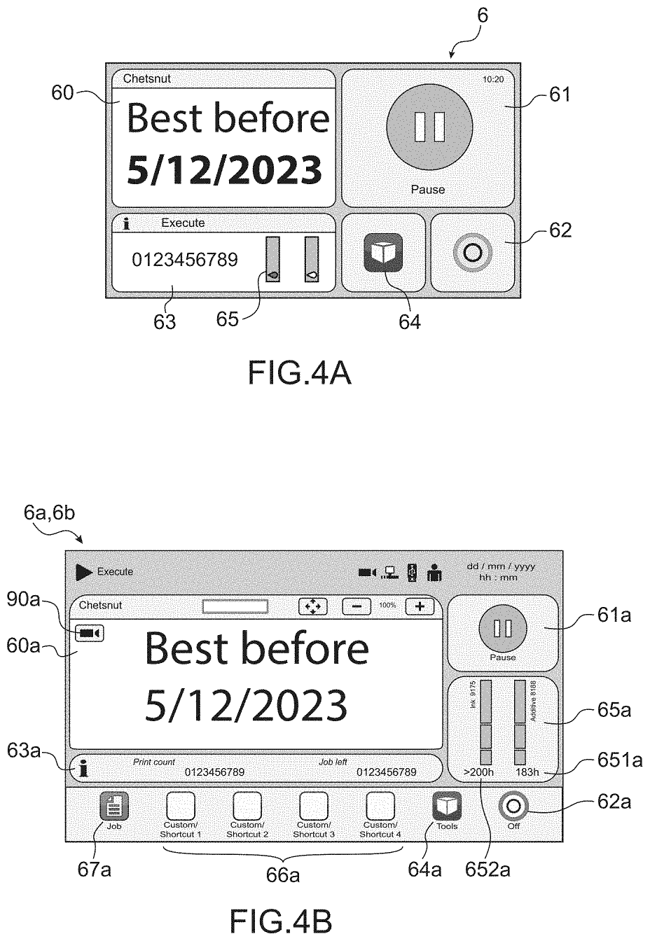

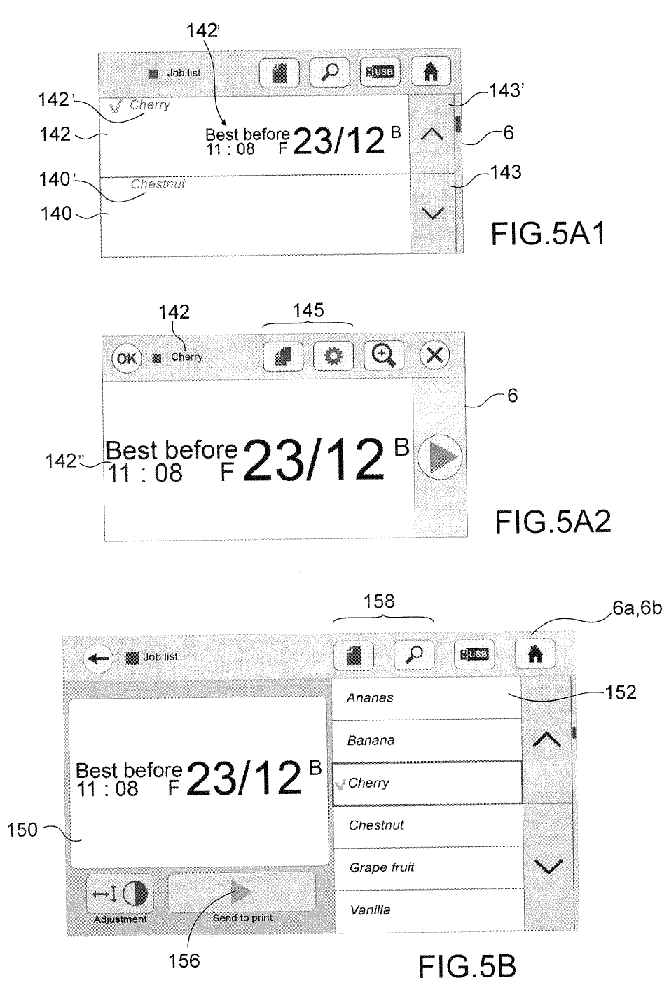

First aspects of the invention are disclosed in connection with FIGS. 2 and 3.

In FIG. 2 the body 3 or the controller (the expression “controller” will be used throughout this specification but covers both alternatives) of the printing machine comprises a 1st user interface 6 which is a tool for an operator to manage the printer, for example by entering control data and/or at least one instruction, and to be informed about its operation.

This 1st user interface comprises a screen (the 1st screen) where technical information regarding the printer and/or status of the printer and/or a message (and/or information) being printed or to be printed and/or a filling information of an ink and/or solvent cartridge (more generally: of a consumable material) can be displayed in one or several different fields.

The 1^{st} user interface, like all other user interfaces in this application, can receive from the controller one or more data or information to be displayed and/or send to the controller, or provide it with, one or more data or instruction for example further to the operator's selection of a particular button or icon of the user interface, for example a “stop” button. In this application, the expressions “button”, “icon” will be considered as designating the same technical means, for example to select a specific operations or status of the printer.

For any reason, in particular in case of failure, one may have to replace the 1^{st} user interface or the 1^{st} screen 6 by another (or 2^{nd}) user interface or screen 6a, for example a larger screen or user interface than screen or user interface 6.

However the controller is programmed for displaying the information on the screen 6.

According to the invention, the controller detects the size of the 2^{nd} screen 6a (it reads or receives an information related to the size of the screen or containing a data related to the size of the screen) and adapts the information display based on said size information or said size data. Example of screen sizes are 4.3 inch, 7 inch and 10.1 inch (this size is the diagonal of the screen); the screens can be of different shapes and/or formats, e.g. a wide screen, or a 4:3 (aspect ratio) screen or a square screen.

FIG. 3 shows another situation where the present invention can be implemented; a 2^{nd} user interface or 2^{nd} screen 6b is used in addition to the first user interface or screen 6. The operator can look at both screens when he is closed to both of them simultaneously. Alternatively, if he is away from screen 6, he may still have and read information displayed on display 6b.

In both cases (FIG. 2 and FIG. 3), and also in most cases in this application, the 1st user interface 6 is mechanically connected to the controller so that it cannot be displaced away from the controller. It can be fixed to the controller. It can be rotatable around an axis or movable along an axis, any of said axis being fixed with respect to the controller but it remains mechanically connected to the controller. An operator can see the information displayed on this 1^{st} user interface and, depending on said information, interacts with the machine as explained below when staying in front of the controller.

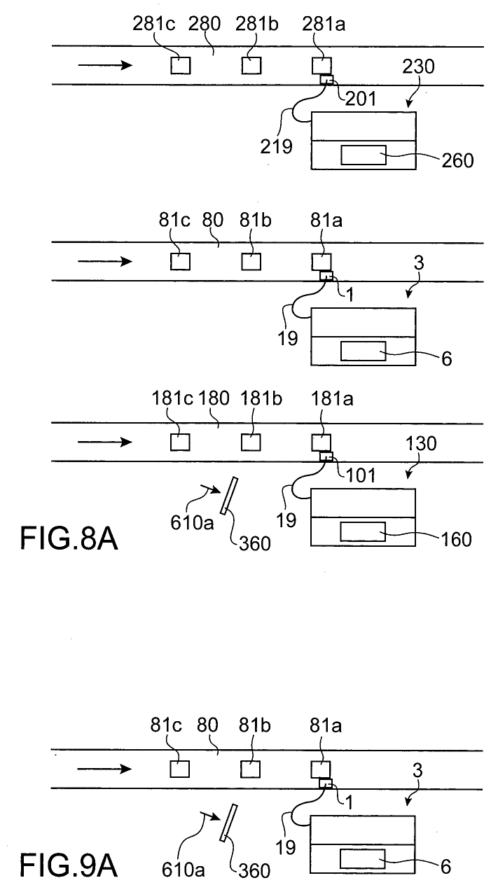

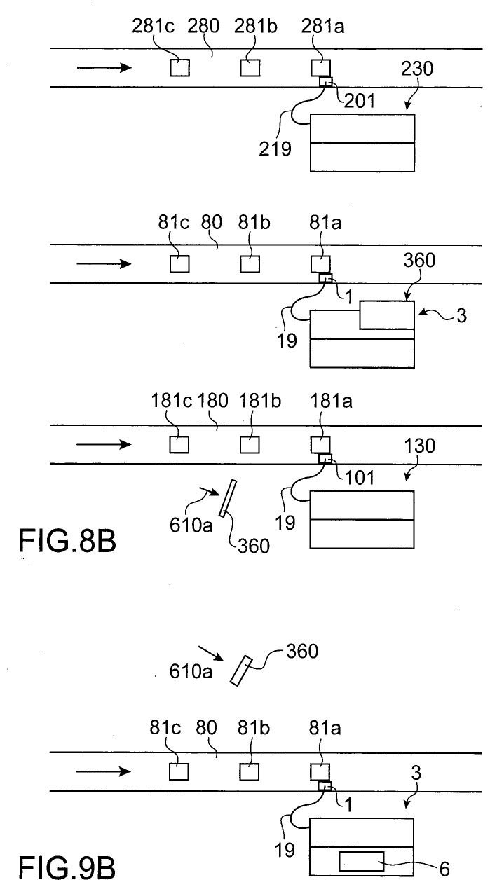

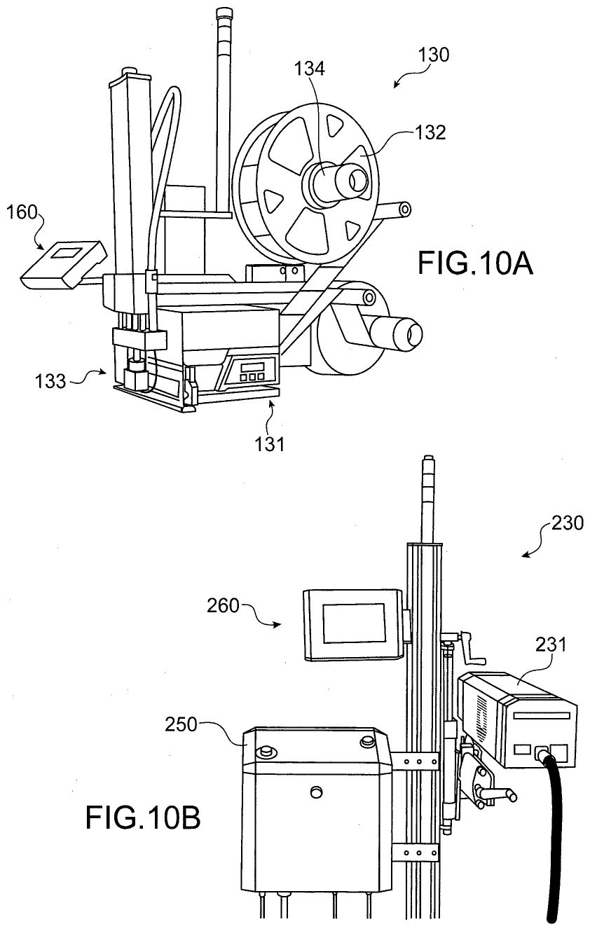

In the situation of FIG. 3, a 2^{nd} user interface or 2^{nd} screen 6b is used in order to allow the operator some flexibility around the printer, for example to check the print head 1 or to check a conveyor on which objects to be marked by the printer are transported (see for example the situations of FIGS. 8A, 8B and 9A, 9B). Said second user interface or screen 6b can have a different size than the 1st user interface or screen. In this particular case, said second user interface or screen 6b is larger than said 1st user interface 6. In another embodiment, said second user interface or screen 6b is smaller than 1st user interface 6 (it is for example a portable, hand held device).

Said 2^{nd} user interface 6b is preferably movable or portable or displaceable with respect to the controller, unlike the 1^{st} user interface 6. It can be displaced by an operator at some distance from the controller, while still displaying the same information. The distance between the print head or the 2^{nd} user interface and the controller (and the 1^{st} user interface) can be of the order of several meters, for example between 2 m and 10 m or 15 m.

Each of the 1^{st} and 2^{nd} user interfaces can receive from the controller one or more data or information to be displayed and/or send to the controller, or provide it with one or more data or instruction, for example further to the operator's selection of a particular button or icon of the 1^{st} user interface or of the 2^{nd} user interface (FIG. 3), for example a “stop” button.

According to the invention, the controller detects the size of the second screen 6a, 6b (it reads or receives an information related to the size of the screen or containing a data related to the size of the screen) and adapts the information display based on said size information or said size data. Example of screen sizes are given above. In the example of FIG. 3, the 2^{nd} user interface communicates with the controller by wireless communication 600. In one embodiment, this 2^{nd} user interface 6b is equipped with wireless communication means, for example an a WiFi or Bluethooth type interface, that can allow a wireless dialogue or exchange 600 (see FIG. 3) of information or data with the printer controller 3, particularly to receive from it one or more data to be displayed and/or to send it or provide it with one or more data or instruction sent further to the operator's selection of a particular button of the 2^{nd} user interface, for example a “stop” button.

The operator can thus take the 2^{nd} user interface away to perform any task for example on a production line while still seeing some information displayed, which is sent by the controller and/or while still having the possibility to send information to the controller.

The information displayed on both 1st and 2^{nd} interface is generated by the controller 3 and sent to the relevant interface, according to its size, either though electrical connections (to the 1^{st} user interface) or through wireless connection 600 (to the 2^{nd} user interface).

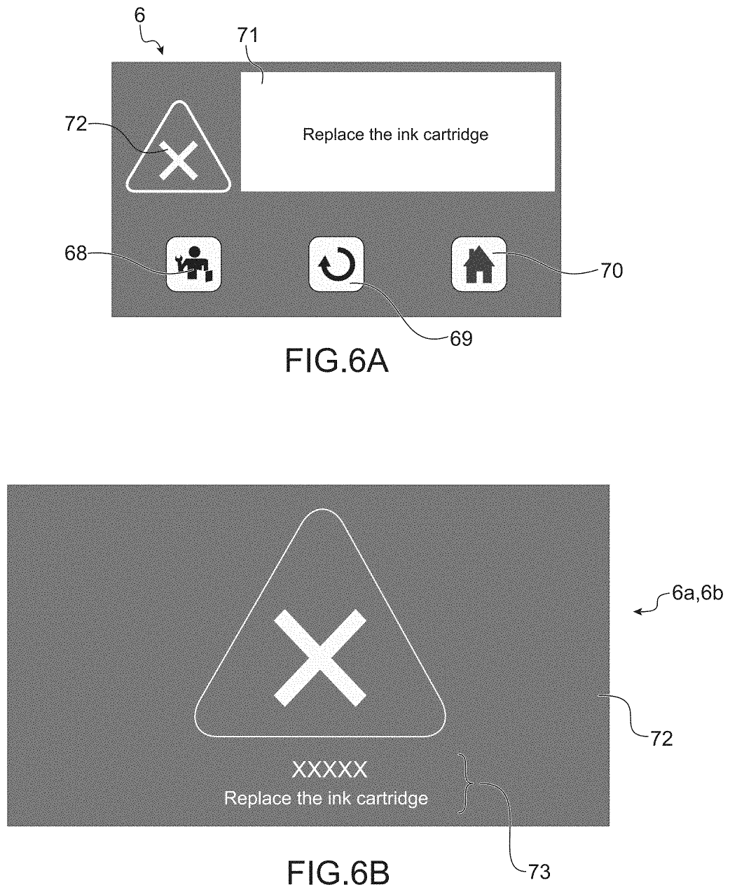

The examples of FIGS. 4A-4B, 5A1-5B and 6A-B are applicable to both embodiments of FIGS. 2 and 3.

One example of one embodiment of the 1^{st} screen 6 is illustrated on FIG. 4A:
a field 60 displays the information to be printed,
a button or icon 61 displays a «pause» message or symbol while the machine in printing; selecting this button, an operator will interrupt the printing operations with a possibility to resume printing by selecting another button (not shown on FIG. 4A but it will be displayed after the button 61 has been pressed) while the machine is temporarily not printing;
another button 62 displays a «stop» message or symbol while the machine in printing; selecting this button, an operator will stop the printer; or, according to another example, it will stop heating a “hotmelt” ink;
another field 63 of the screen may display a number of printings or of messages already printed by the printing machine and/or an information about the quantity of consumable remaining, for example a quantity of ink and/or solvent and a possible remaining time of use before replacing or refilling a cartridge or a reservoir of the corresponding consumable; other examples of consumables are given below and an information relating to them can be displayed on this 1^{st} screen;
another button 64 can display a symbol or message to give the operator access to one or several tools, like for example a log and/or a diagnostic (for example in case of a failure of a part of the device), and/or one or more settings, and/or data transfer, and/or a calendar . . . .

The 1^{st} screen may display one or several buttons which the operator can select to change a work flow of the printer or to change the status (for example: working or stopped) of the printer.

This 1st interface therefore gives an operator a certain number of technical information, some of them giving him the possibility to interact with the work flow of the printer, for example by stopping the printer or by selecting specific tools or functions.

As illustrated on FIG. 2 (respectively FIG. 3), a 2^{nd} user interface 6a (respectively 6b), which may also comprise a screen (the 2^{nd} screen), can be used instead of (respectively in combination with) the 1^{st} screen. It can have a different size than the 1^{st} one; it is for example larger, in which case said 2^{nd} user interface 6a, 6b can display the same type of information as the 1st user interface and another information not displayed on the 1st user interface. The above description and the above list of information are therefore examples also applicable to the 2^{nd} user interface and will not be repeated. But, since the 2^{nd} user interface is larger the 1st user interface, more technical information can be available on said 2^{nd} user interface.

In the case of FIG. 3, the same information needs not be displayed on both user interfaces. For example, and in particular if the 2^{nd} user interface is larger the 1st user interface, more technical information can be available on said 2^{nd} user interface.

For example (which can apply to both examples of FIGS. 2 and 3), as illustrated on FIG. 4B, the 2^{nd} user interface not only displays the information or fields displayed by the 1st user interface but further displays the number of printings remaining to be made («Job left», 63a) and a button 67a (“Job”) gives access to more detail about the printing being currently performed. The above description and the above list of information are therefore examples also applicable to the 2^{nd} user interface and will not be repeated. But, since the 2^{nd} user interface is larger the 1st user interface, more technical information can be available on said 2^{nd} user interface.

On the example of FIG. 4B, buttons or icons and fields 61a, 62a, 64a, 60a display the same information as buttons or icons and fields 61, 62, 64, 60 of FIG. 4A; but, with respect to FIG. 4A, further information is displayed, for example the information concerning the time 651a, 652a remaining before a consumable product is partly or totally consumed. On FIG. 4B, reference 651a, respectively 652a, is the remaining time before an ink cartridge, respectively a solvent cartridge, must be replaced. This information is displayed in a field 65 also including a pictogram for each of the consumable level in each of the ink and solvent cartridges. The screen of FIG. 4A displays only the pictograms 65 for each of the consumable level, not the information about the remaining time. Another information relating to a consumable can be a lifetime of a hydraulic and/or mechanical part and/or an electrical part of the printer, for example a valve or a pump of a hydraulic circuit of the printer. In this case, the pictogram can represent and/or identify and/or locate the corresponding part together with an information relating to an estimated remaining lifetime of said part.

Buttons, or fields or icons, for example custom or shortcut buttons 66a, are not present on screen 6 of FIG. 4A, which has a smaller size than the screen of FIG. 4B. But the smaller screen 6 can have a button or a field or an icon to access one or more buttons or fields or icons not displayed on screen 6.

A 3^{rd} user interface, which may also comprise a screen (the 3^{rd} screen), can be used instead of the 1^{st} screen and of the 2^{nd} screen (or in combination with one of them, as explained in relation with FIG. 3). It can have a different size than the 1^{st} one and the second one, it is for example larger (respectively smaller) than the 1^{st} one but smaller (respectively larger) than the 2^{nd} one. Said 3^{rd} user interface can display the same type of information as the 1st user interface and the 2nd user interface, but:
more (respectively less) information than the 1st user interface or additional information not displayed on the 1st user interface (when the 3^{rd} user interface is larger, respectively smaller, than the 1^{st} one);
less (respectively more) information than the 2^{nd} user interface, which contains additional information not displayed on the 3^{rd} user interface (when the 3^{rd} user interface is smaller, respectively larger, than the 2^{nd}).

Another example is illustrated on FIGS. 5A1-5B, here again with a 1^{st} user interface 6 (FIG. 5A1 or 5A2) smaller than the 2^{nd} user interface 6a (FIG. 5B).

This example concerns a job select screen: a printer has a text editing software, or text editing means, to prepare a text and/or images and/or symbols to be printed on a product.

The buttons and/or functions displayed to a user can be different depending on the size of the user interface.

FIG. 5B shows an information display when the 2^{nd} user interface (the largest one) is used in combination with the printer and the controller:
a field 150 displays the information to be printed,
a list 152 of products from which a specific product can be selected and for which a message to be printed must be edited (or prepared for print);
a button 156 displays a «send in printing» message or symbol to launch or start a printing of a message which has been prepared by the user with help of the text editor;
other fields 158 of the screen may give access to one or several further functions, like duplicating at least a portion of an already existing message to another message (being created or edited) or starting a new edition for a new message.

FIG. 5A1 shows an information display when the 1st user interface 6 (the smallest one) is used in combination with the printer and the controller: a more compact information is displayed on this user interface 6 than on the user interface 6a of FIG. 5B. Actually a list of products together with a standard message to be printed for each particular product is presented to the user; in the example shown on FIG. 5A1, a first product name 142′ appears in a first field 142 in combination with a standard message 142″ for this first product and a second product name 140′ appears in a second field 140. A user can select the products and the corresponding standard messages to be displayed from a list with help of for example appropriate buttons 143, 143′ to scroll up or down said list.

Upon selection of a specific product, only one message 142″ is displayed together with the name 142′ of the product concerned (FIG. 5A2). One or several buttons 145 give the user a possibility to select another product or another combination of product and message.

In other words, FIGS. 5A1 and 5A2 represent 2 successive steps. Due to the limited space on the screen 6 the job selection is performed in two steps with two successive screens: the list of jobs appears on FIG. 5A1 and the selection of a job on the screen of FIG. 5A1 results in the more detailed display of FIG. 5A2 (which can have the button «send to print»).

Another example is illustrated on FIGS. 6A-6B, here again with a 1^{st} user interface 6 smaller than the 2^{nd} user interface 6a.

This example concerns a situation where a default is detected during printing.

The information displayed on the 1^{st} user interface 6 is shown on FIG. 6A.

A button 68 gives the operator the possibility to display further information, for example a guide and/or a button 69, giving the operator the possibility to perform a warning or a fault, for example after he/she has performed a maintenance or has repaired the printer and/or a button 70 giving the operator the possibility to display the home screen (on which a warning can still be displayed). This figure is an example of a display when a failure is detected in the machine; a failure message 71, for example together with a failure signal or pictogram 72 is displayed on the user interface.

FIG. 6B concerns the 2^{nd} user interface 6a, which size is larger than the 1^{st} user interface. In this example the content of the information displayed is different from the information displayed on the 1^{st} user interface: according to the example illustrated on FIG. 6B, the 2^{nd} user interface then only displays a large failure signal 72, with a possible access to further information button or field 73 on which the operator can press to receive further details as to the failure.

The same example can be adapted to a warning message, instead of a failure message, buttons 68, 69, 70, remaining the same as on FIG. 6A, the failure message 71, respectively the failure signal or pictogram 72 of FIG. 6A being replaced on the user interface of FIG. 6B by a warning message, or by a warning signal or pictogram.

In other words, when the 2^{nd} user interface is used for this printer or controller, the information displayed on the 2^{nd} user interface is adapted by the controller, and is different from the set of information displayed on the 1^{st} user interface. The information displayed on the 2^{nd} user interface can be adapted to display only part of the information displayed on the 1^{st} user interface. For example the 2^{nd} user interface of FIG. 6B only displays the failure signal which is one of the signals displayed on FIG. 6A. In a variant, the 1st user interface 6 only displays part of information displayed on the 2^{nd} user interface 6a, but said part of the information is made larger on the 1st user interface than on the 2^{nd} user interface so that the operator only sees a limited number of information (but an expanded information) on the 1st user interface.

This feature can be useful in that the operator's attention can be focused on an essential information: on FIG. 6B the 2^{nd} user interface essentially displays an expanded warning pictogram and a short description of a fault.

Based on this example, one understands that displaying on the 1^{st} user interface only one button or field or icon indicating the state of the machine (or any other information) can be important when the operator is far away (for example at a distance between 2 m or 5 m and 10 m) from the 1^{st} user interface (he is for example close to the printing head), because he can then see this information (on the 1^{st} user interface) while having the 2^{nd} user interface which displays other information.

The following examples are other situations where there is a distance between the controller (where the 1^{st} user interface is located), the print head and the operator (holding the 2^{nd} user interface) and where it can be important for the operator to see the information on the 1^{st} user interface even when he/she is at some distance (for example at a distance between 2 m or 5 m and 10 m) from it:
the controller and print head can be on different sides of a conveyor;
or the controller has several print heads, and the print heads print on different sides of the production line;
or the controller has several print heads and the print heads print on two different production or packaging lines;
or the controller is integrated under the conveyor and the print head is located on the conveyor for printing on products.
or the controller is integrated in a packaging machine or system, and the user and the 2nd interface are located outside the packaging machine or system.

When a printer according to the invention is started, an information is sent to the controller concerning the size of the user interface. The controller selects a corresponding library of information to be displayed for this specific size (or 1^{st} size) of user interface. If another user interface with another size (or 2^{nd} size) is used instead of the 1^{st} size, or if another user interface with another size (or 2^{nd} size) is used in combination with a user interface having said 1^{st} size (like on FIG. 3), the controller selects a corresponding library of information to be displayed for this specific 2^{nd} size of user interface. The controller can memorize several (at least 2 or 3) libraries of information to be displayed for several (at least 2 or 3) user interface, each one in connection with a specific size of user interfaces; in other words, it can memorize or memorizes a list or a set of sizes of user interface and, for each size, a library or a set of information to be displayed for each step. The controller has also means to compare an information related to, or representative of, the size of a user interface with said list or with said set of sizes and to select the corresponding library or set of information to be displayed.

According to another embodiment, which can be combined with the preceding one, the controller can:
first detect the size of the screen, analyze the available space;
and, depending on the available space and/or on the priority of different elements to display and/or the size of the screen, the controller selects which elements to display and adapts the size of the elements to fit into the screen. This allows for a dynamic display of elements depending on the screen size.

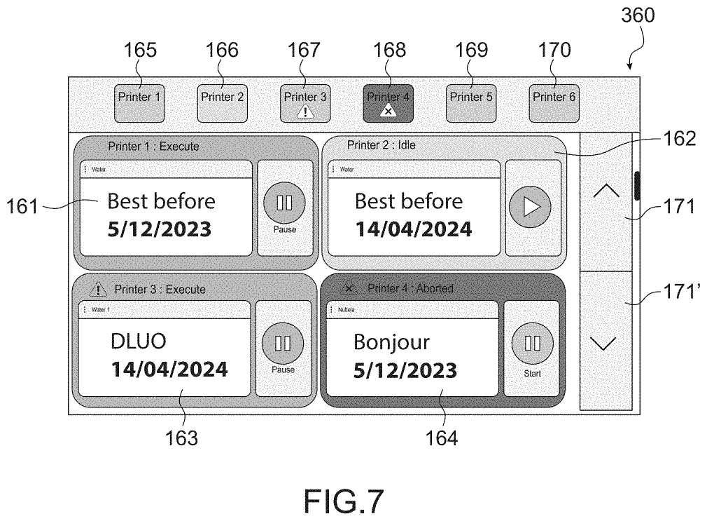

Another aspect of this invention will be explained in connection with FIG. 7.

It concerns a situation where a same user interface 360 is used for several printers, the user interface being divided for displaying information to different printers simultaneously. In such situation, the same user interface or screen is divided into several fields, one for each of several printers, and the information for each of said several printers is displayed in the corresponding field as if a smaller user interface was used in connection with that particular printer.

FIG. 7 shows a user interface 360 displaying several (4 in this example, but it can be any number, 2 or more than 2) different fields 161-163, each one displaying the information for each one of the several printers. In each field, the technical information displayed is not the same as the information which would be displayed for that particular printer if the user interface was only displaying information for that particular printer

In this example there is a controller for each printer. Screen 360 is controlled by any of said controllers, adapted or programmed accordingly.

The number of printers displayed can depend on the screen size; alternatively more information could be displayed for each printer if a larger screen is used.

For example the user interface 360 could display information relating only to a 1^{st} printer as on FIG. 4A; but, when user interface 360 is used in combination with this 1^{st} printer and other printers, the information relating to that 1^{st} printer is more compact and different from the information of FIG. 4A, because information relating to at least another printer is displayed simultaneously with the information relating to the printer. The same holds for more printers, FIG. 7 showing an example with 5 additional printers 2-6. In one embodiment, means (buttons 165-170 in this example) allow the user to select one of said printers which can result in a display on the whole user interface 360 for this particular printer. For example, by selecting printer 1 through button 165, the user interface displays information like on FIG. 4A, but only for printer 1. A “home” button can be added to the display of FIG. 4A in order to come back to the display of FIG. 7 for several printers.

In a further embodiment a user can select the printers to be displayed from a list with adapted means, for example appropriate buttons or icons 171, 171′ to scroll up or down said list. For example, pressing on button 171′, a user can display the information for printers 3-6 (instead of printers 1-4 on FIG. 9).

According to this embodiment, more printers can be accessed from the shortcut buttons (165-170) and/or by scrolling up and down in a list using means 171, 171′.

A specific information on a state of one or several of said printers can be displayed: in the example of FIG. 7, printers 1 and 3 are executing a print whereas printer 2 is idle and the print of printer 4 has been interrupted. This gives an operator or a user an information on the state of the different printers he is managing or watching.

FIG. 8A illustrates another aspect of the invention and represents a situation where 3 printers (or controllers) 3, 130, 230 are installed near 3 conveyors 80, 180, 280 (represented from above), each printer being near one of said conveyors to control it and to control the printing operations it performs; each conveyor transports goods 81a, 81b, 81c . . . (resp. 181a, 181b, 181c; 281a, 281b, 281c) to be printed with help of the print head 1, 101, 201 connected to the controller 3, 130, 230 through the umbilical 19, 119, 219.

The field 161-164 for each printer is adapted to fit the display size of user interface 360.

Each controller has its own screen or user interface 6, 160, 260 displaying information concerning the corresponding conveyor and printer.

A further screen 360—which can have the same size as any of the user interfaces 6, 160, 260, or different size from all user interfaces 6, 160, 260—displays information relating to all 3 conveyors as disclosed above in relation with FIG. 7 (the example of FIG. 7 can of course be adapted to 3 printers or to any number different from 4). Screen 360 is controlled by any of the controllers, adapted or programmed accordingly.

In the different aspects disclosed above (in particular in relation to FIG. 7 and FIG. 8A) the communication between screen 360 and each of the controllers can be of the Ethernet, or WiFi, or Bluetooth type or of any other wireless type. Screen 360 can either automatically detect all printers, which belong for example to a network, or be manually configured to have a list of specific printers.

In the different aspects disclosed above (in particular in relation to FIG. 7 and FIG. 8A) screen 360 makes it possible to have an overview of several user interfaces for several printers, as explained above in connection with FIG. 7; thus, it is for example possible to display, for each of several printers, the production status and/or a status of the corresponding printer and/or to launch some action, for example starting or stopping a printing operation and/or changing the content of a job, . . . . It is possible to display on screen 360 the same user interface as the user interface 6, 160, 260 of each printer and to take the control on each individual printer e.g by clicking on one of the buttons 165-170 (see FIG. 7). In other words, the user interface 360 can show information simultaneously for several printers; in a further embodiment, user interface 360 can also display information relating to only one printer individually and it is possible to shift from a display of information simultaneously for several printers to a display of information for only one printer and back to a display of information simultaneously for several printers. In both cases, for each individual printer, the information is not displayed on the same portion of user interface 360, and is therefore not displayed with the same size: in one case (simultaneous display for several printers), the information displayed for each printer is on a smaller size than in the other case (display for only one printer). For this reason, the content of the technical information displayed is preferably adapted to the available size, as disclosed above, for example in relation with FIGS. 2-6B. The controller controlling user interface 360 can be programmed to detect a surface or an area indicating a size available on said common user interface for each of said individual printers and adapt the technical information to be displayed on said user interface based on said detected surface or area. The surface or the area indicating a size available depends on whether the interface 360 displays information simultaneously for several printers or information relating to only one printer.

An operator cannot control or monitor each of the controllers 3, 130, 230 with the help of all user interfaces 6, 160, 260, at the same time if the controllers are too far away from each other. Alternatively he/she can be away from all user interfaces 6, 160, 260 as illustrated on FIG. 8A where he is staying near conveyor 180 but without any possibility to see what the different user interfaces 6, 160, 260 display.

User interface 360 gives the operator a simultaneous information on each of the different printers, even if this information is not as detailed as on each of said user interfaces 6, 160, 260. If one of the printers is interrupted for any reason, the operator is informed by user interface 360 and can come closer to the corresponding controller and look at the detailed information displayed on the corresponding user interface 6 or 160 or 260. He may also decide to see more information for that particular printer only with help of the corresponding means 165-170 on the screen as explained above.

In a variant the system of FIG. 8A has none of the individual user interfaces 6, 160, 260. In other words, in this embodiment, there is only one user interface 360 (for example like on FIG. 7) for the whole system. Each of the printers is then of the “headless” type, the communication between screen 360 and each of the controllers being of the Ethernet, or WiFi, or Bluetooth type or of any other wireless type.

FIG. 8B represents another example, similar to the one illustrated on FIG. 8A (common references and elements will not be described again) where it is possible to plug the common user interface on one, or (successively) more than one, of the controllers 3, 130, 230.

In this example, the user interface 360 also comprises means of the electric contact type, for example with a 1^{st} part of a plug; one or more, or each, of the controllers has a 2^{nd} part of the plug which can cooperate with said 1^{st} part of the plug. Thus, the 1^{st} part can for example be plugged on (or with) any of said controllers having such a 2^{nd} part. The 1^{st} part and each 2^{nd} part can be of the plug and socket type. FIG. 8B shows screen 360 plugged on controller 3. In such a situation, user interface 360 is physically (including mechanically and electrically) in contact, or plugged, with the controller 3. Alternatively, the user 360 interface can be linked to the controller of any printer through a wire or a cable (and at least one plug). When the user interface 360 is plugged on or with a particular controller, information or data can be exchanged between said user interface 360 and said particular controller through the 1^{st} part and the 2^{nd} part of the plug and/or through at least one wire. In particular the user interface 360 can receive from the controller with which it is plugged one or more data to be displayed and/or it can send to said controller, or provide it with, one or more data or instruction sent further to the operator's selection of a particular button of the user interface 360, for example a “stop” button.

More generally, according to this variant, the user interface 360 comprises means to be directly connected with an individual controller, through a physical connection. The user interface 360 is directly connected with a particular printer when it is plugged to this particular printer or connected with it through a cable. In this case, the display on said user interface 360 is changed from the display of FIG. 7 (adapted to the corresponding number of printers) to the display of information relating to only the particular printer on which it is plugged, like on FIG. 4A or 4B for example: the simultaneous display of information related to the several controllers or printers of FIG. 7 is thus replaced by a specific display of information concerning only the particular controller or printer on which the user interface 360 is directly connected. This can be particularly interesting when each of the printers is of the “headless” type, as explained above (there is none of the individual user interfaces 6, 160, 260). When user interface 360 is unplugged from said particular printer, the display can again be related to several printers simultaneously, like in the example of FIG. 7.

Here again, for each individual printer, the information is not displayed on the same portion of user interface 360, and is therefore not displayed with the same size: in one case (simultaneous display for several printers, user interface 360 is unplugged from any particular printer), the information displayed for each printer is on a smaller size than in the other case (display for only one printer, user interface 360 is plugged to or on a particular printer). For this reason, the content of the technical information displayed is preferably adapted to the available size, as disclosed above, for example in relation with FIGS. 2-6B. The surface or the area indicating a size available depends on whether the interface 360 displays information simultaneously for several printers or information relating to only one printer.

FIG. 9A represents a situation where one printer (or controller) 3 is installed near a conveyor 80 represented from above; conveyor 80 transports goods 81a, 81b, 81c . . . to be printed with help of the print head 1 connected to the controller 3 through the umbilical 19.

The controller has its own screen or user interface 6 displaying information concerning the conveyor 80 and the printer.

A further screen 360 may have a different, for example smaller, size than user interface 6. In this case, based on the teaching of the present invention, the controller detects the different size and adapts the information sent to user interface 6 for presentation according to said size, as already explained above. For example, screen 6 displays information according to FIG. 4B or 5B or 6B whereas screen 360 displays a different information for example as disclosed above in relation with FIG. 4A, 5A1, 5A2 or 6A.

The operator looks at user interface 360 if he is staying away from said user interface 6 as illustrated on FIG. 9A (where he is staying near conveyor 80 but without any possibility to see what the user interface 6 is displaying). In particular, the operator cannot control, or look at, controller 3 with the help of user interface 6 from which he/she is too far away. In an embodiment, the operator can control controller 3 with the help of user interface 360 and/or can control the content of said user interface 6 through user interface 360, both user interfaces communicating with each other preferably by wireless communication, for example of the Ethernet, or WiFi, or Bluetooth type or of any other wireless type).

This is in particular the case if the operator is staying on the other side of the conveyor than the controller 3, as illustrated on FIG. 9B. The operator looking in the direction illustrated by arrow 610a at the user interface 360 still sees the information he needs, while the 1^{st} user interface 6 is still displaying all information (which however cannot be seen by the operator).

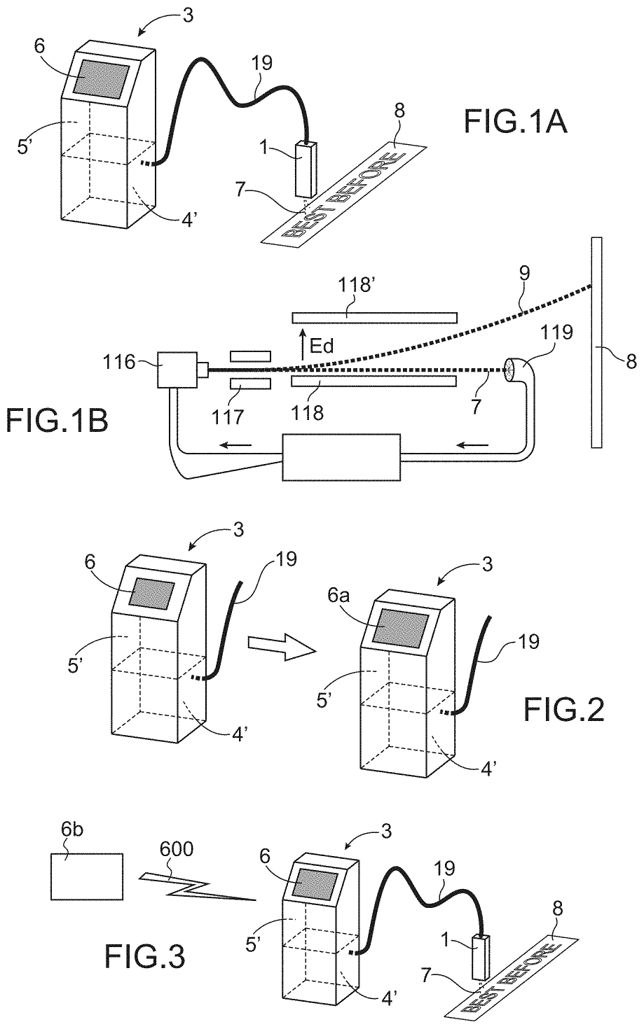

The invention is disclosed above for an inkjet printer, for example a CIJ inkjet printer. A CIJ printer has for example a structure as explained above in connection with FIG. 1A and a print head as explained above in connection with FIG. 1B. But it can also be implemented in combination with another kind of printer, for example a laser printer, or a TIJ (Thermal inkjet) printer or a “print and apply” printer (where a label is printed and then applied to a product) or a DOD (“drop on demand”) printer or a “valvejet” printer. Each of these printers has technical features and technical information or parameters relevant to each of said printers which can be displayed on user interfaces having different sizes. For example, in the case of a laser printer, the laser filter status can be such a parameter; in another example the ribbon length for a TTO printer is such a parameter.

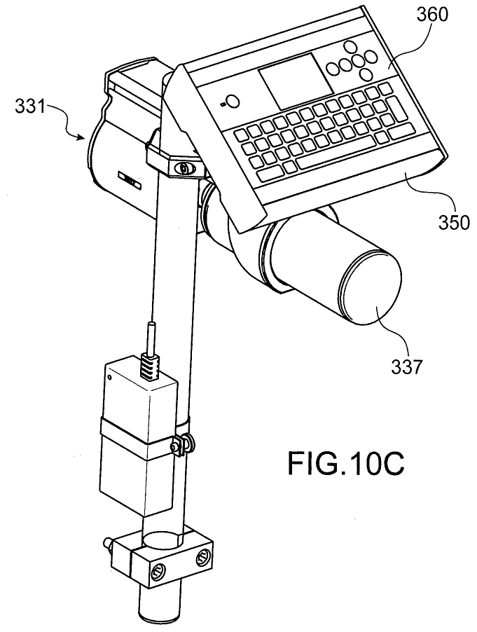

An example of a “print and apply” printer 130 (where a label is printed and then applied to a product) is represented on FIG. 10A and comprises a section 131 or means (based for example on thermal printing) for printing information on stickers from a ribbon 132 and a section 133 or means for sticking these stickers on an object or a surface of a packaging. Said section 133 or means for sticking comprise for example a plunger or a tamping machine or a hydraulic circuit for generating pulsated air. A ribbon 132 can be loaded on a ribbon core 134, is then guided to the printing section 131 and further to the section 133 for sticking the stickers on a surface, for example of a container or of a packaging. The printer also includes a controller and a user interface 160, corresponding to the 1^{st} user interface according to the invention.

An example of a laser printer 230 is represented on FIG. 10B and comprises a laser head section 231 for printing information on a surface, a controller 250 (which controls in particular the parameters of the laser) and a user interface 260, corresponding to the 1^{st} user interface according to the invention.

An example of a “valvejet” printer 330 is represented on FIG. 10C and comprises a printhead 331 (of the “drop on demand” ink jet type) controlled by a controller 350 and a user interface 360 (which can be both combined) said user interface 360 corresponding to the 1^{st} user interface according to the invention. An ink cartridge 337 can be connected to the printhead 331.

An example of a thermal transfer printer is disclosed in U.S. Pat. No. 9,145,020 and includes a plurality of printing elements controlled by a controller and a user interface, corresponding to the 1^{st} user interface according to the invention.

Another example of a thermal transfer printer is disclosed in U.S. Pat. No. 7,372,475 and includes a thermal print head controlled by a controller and a display device or user interface, corresponding to the 1^{st} user interface according to the invention.

In both documents, the print head or the printing elements transfer(s) a marking medium from a web to a substrate. A ribbon can be loaded in a ribbon cassette, as for example disclosed in U.S. Pat. No. 8,665,301. Ribbon tension and ribbon speed can be controlled and the thermal control on the print head can be controlled to transfer the ink from the ribbon to the material to which it is to be applied. In an embodiment the melted portion of the ribbon stays glued to the material on which the print is applied.

In all the above examples, and more generally in the context of the present invention, printing is performed on a surface which is not a paper sheet; it can be the surface of an object or a packaging of an object or of several objects. The surface to be printed on is sometimes not flat, for example when printing must be performed directly on the surface of an object like a bottle or a can or a container or a cable.

A drop on demand printer is disclosed in U.S. Pat. No. 4,584,590 and can be implement in a device and a method according to the invention.

A thermal ink jet printer is disclosed in U.S. Pat. No. 4,490,728 and can be implement in a device and a method according to the invention.

Another ink-jet head structure is disclosed in U.S. Pat. No. 5,605,659 and can be implement in a device and a method according to the invention.

In all said devices a controller can control the printing system and a user interface, corresponding to the 1^{st} user interface according to the invention, can be implemented.

The examples of FIGS. 8A and 8B may concern 3 printers of the same kind: all are for example CIJ printers. According to a further aspect of the invention, at least two of said 3 printers can be of different kinds, for example a CIJ printer and 2 laser printers.

Preferably, in any embodiment of the invention, the control means, or controller, 3 (or 130 or 230) comprises a processor or microprocessor, or an electrical or electronic circuit programmed to implement a method according to the invention or one or several steps of a method according to the invention. These means may also control the printing operations, for example, in a CIJ printer, the opening and the closing of each valve of the hydraulic circuit, as well as the activation of the pumping means, in order to circulate ink and/or solvent. It also memorises data, for example ink and/or solvent level measurement data, and may also possibly process these data.

In particular, in some embodiments, the 2^{nd} user interface also has a processor or microprocessor, or an electrical or electronic circuit programmed to implement a method according to the invention or one or several steps according to the invention.

What is claimed is:

1.-11. (canceled)

12. A printing system comprising several industrial printers, each printer comprising a controller to control printing operations, said system further comprising a common user interface, one of said controllers being programmed to simultaneously display on said common user interface an information relating to at least two of said printers and/or of printing operations performed by said printers.

13. A printing system according to claim 12, each one of said industrial printers further comprising an individual user interface, a controller of each one of said industrial printers being programmed to display on said individual user interface of said printer information relating to said one of said industrial printers only and/or to printing operations performed by one of said industrial printers only.

14. A printing system according to claim 12, said one of said controllers, which is programmed to simultaneously display on said common user interface an information relating to at least two of said printers, being programmed to shift from a display, on said common user interface, of simultaneous information relating to at least two said printers to a display of information relating to only one of said printers and vice-versa.

15. A printing system according to claim 14, said controller being programmed to detect a surface or an area indicating a size available on said common user interface for each of said printers and adapting the technical information to be displayed on said user interface based on said detected surface or area.

16. A printing system according to claim 12, said controller being programmed to display on said common user interface means for selecting an information display relating to at least two of said printers or to only one of said printers.

17. A printing system according to claim 12, said controller being programmed to display on said common user interface buttons or icons for selecting an information display relating to at least two of said printers or to only one of said printers.

18. A printing system according to claim 12, said common user interface comprising wireless interface to exchange data with the controller of each of said industrial printers.

19. A printing system according to claim 12, at least one of said industrial printers being different from, or of a different kind than, another one of said industrial printers.

20. A printing system according to claim 12, each industrial printer being selected from among a continuous inkjet printer or a laser printer, or a thermal inkjet printer or a “print and apply” printer or a drop on demand printer or a valvejet printer.

21. A method to control printing operations, implementing a printers system according to claim 12.

22. A method to work a printing system comprising several industrial printers, each printer comprising a controller to control printing operations, said system further comprising a common user interface, one of said controllers controlling said common user interface so that it simultaneously displays an information relating to at least two of said printers and/or an information of printing operations performed by said printers.

23. A method according to claim 22, further comprising shifting said display on said common user interface from a display of information simultaneously for several printers to a display of information for only one printer and back to a display of information simultaneously for several printers.
